(19) United States
(12) Patent Application Publication
(10) Pub. No.: US 2016/0063507 A1
(43) Pub. Date: Mar. 3, 2016

(54) METHOD, SYSTEM AND PROGRAM PRODUCT FOR PRODUCT AND SERVICE REGISTRATIONS

(71) Applicants: Ming Gao, San Jose, CA (US); Meng Wang, San Francisco, CA (US)

(72) Inventors: Ming Gao, San Jose, CA (US); Meng Wang, San Francisco, CA (US)

(21) Appl. No.: 14/471,913

(22) Filed: Aug. 28, 2014

(51) Int. Cl. G06Q 30/00; G06F 17/30

(52) U.S. Cl. CPC G06Q 30/012; G06F 17/30879

(57) ABSTRACT

A method, system and program product comprise capturing a product identifier for a product obtained by a user. The product identifier is compiled by a cloud based server system as instructed by a one of a plurality business users of a plurality of different businesses. Extracted information from the product identifier at least comprises a code which uniquely identifies the product and a network address for establishing a communication with the cloud based server system. Personal information is obtained from the user. A communication is established with the cloud based server system using the network address. The code and the personal information is communicated to the cloud based server system. The cloud based server system transmits the code and the personal information to a support center of a business of the business user to use in a registration of the product.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a cloud-based platform. More particularly, the invention relates to network-enabled devices allowing users to consolidate product and service registrations for multiple manufacturers and vendors.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Traditionally, product manufacturers insert a paper-based, product-registration form, such as a postcard, in the product package for consumers to complete and return. Some manufacturers allow product registration via their websites. The registration information allows manufacturers to provide product support to their consumers and to acquire purchase and demographic data that the manufacture and other organizations may use for business purposes.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art appears to show a one-touch application for a mobile device. The application may act as a central point for a support center that provides services for a variety of vendors. This application may allow the user to simply and efficiently register a product with the support center without having to provide detailed information about the product. The application appears to require the user to set up an account with a name, a password, and user preferences. It is believed that the user may use his mobile device to capture an image of a serial number or a universal product code (UPC) and use the application to transmit the image to the support center.

By way of educational background, another generally useful aspect of the prior art is believed to be a computer program that appears to streamline the product-registration process via a website and a mobile device, such as a smart phone. In addition, it is believed that the use of codes imbedded in symbols and a computer database comprising a look-up table, or the like, minimizes manual data entry in a manner that saves time and promotes accuracy. It appears that the registration codes may be embedded in one-dimensional symbols, such as UPCs; however, two-dimensional symbols, such as matrix codes having square- or dot-shaped modules arranged on a grid, or the like, may be preferred. Typically, a product recipient may use a mobile device to capture an image of the registration-related symbol, which it decodes in a conventional manner via software.

In view of the foregoing, it is clear that these traditional approaches leave room for more optimal approaches such as a method that consolidates product and consumer information in one platform for multiple manufacturers and vendors as well as a platform that enables users to utilize a forum for product reviews and warranty information. A solution which does so is desirable.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an image of a sample quick-response (QR) code, in accordance with an embodiment of the present invention;

FIG. 2 is a block diagram depicting a manufacturer-facing, cloud-service, label generation, in accordance with an embodiment of the present invention;

FIG. 3 is a block diagram depicting the processing of a consumer-registration request, in accordance with an embodiment of the present invention;

FIG. 4 is a block diagram depicting a manufacturer-facing, business-intelligence service, in accordance with an embodiment of the present invention;

FIG. 5 is a block diagram depicting a consumer-facing, one-touch, scan-to-register, software application, in accordance with an embodiment of the present invention;

FIGS. 6A-6D illustrate an exemplary software application on a mobile device, in which FIG. 6A is an illustration of the “Scanning Label” page, FIG. 6B is an illustration of the “Scan Successful” page, FIG. 6C is an illustration of the “Consumer Profile” page, and FIG. 6D is an illustration of the “Registration History” page, in accordance with an embodiment of the present invention;

FIG. 7 illustrates an exemplary communication channel, in accordance with an embodiment of the present invention;

FIG. 8 is a block diagram depicting an exemplary client/server system which may be used by an exemplary web-enabled/networked embodiment of the present invention; and

FIG. 9 illustrates a block diagram depicting a conventional client/server communication system.

Unless indicated, illustrations in the figures are not necessarily drawn to scale.

### DETAILED DESCRIPTION OF SOME EMBODIMENTS

The present invention is best understood by reference to the detailed figures and descriptions set forth.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments may provide methods for storage, analysis, and/or management of data. In some of these embodiments, data may be provided by users and/or received from external software. In a non-limiting example, data may include product information received from online databases. Furthermore, some embodiments are specific to either the business user and or the consumer. In a non-limiting example, business users include manufacturers and service providers while consumers include the end user. In some embodiments, the platform includes the following components: a cloud service that allows the manufacturer or the service provider to design, generate, and manage labels as well as to process the consumers' product-registration requests; and a mobile-phone application that allows consumers to scan labels and to manage registration, warranty and socialize.

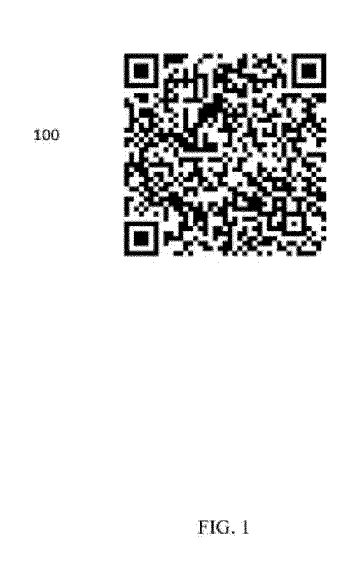

FIG. 1 is an image of a sample QR code, in accordance with an embodiment of the present invention. In the present embodiment, image 100 may be a two-dimensional barcode or a near-field communication (NFC) tag. In a non-limiting example, the two-dimensional barcode could be similar to the popular QR code, or in a format that can be customized into shapes other than QR code's square. In another non-limiting example, the two-dimensional barcode may be printed on tangible material or displayed on a webpage. In the present embodiment, the machine readable code is converted into a text encrypted in the label 100 or NFC tag and can only be decrypted by the system's software 500. In a non-limiting example, the message is a URL link comprising a cloud server appended by clear text or digital hash/checksum, or both. In another non-limiting example, the label 100 may include the manufacturer's ID, the product's ID, the product serial number, the manufacturing date, and an extra survey-flag. In a non-limiting example, the survey-flag indicates that the manufacturer or vendor requires a survey during the registration process. When the cloud server receives the URL request with a survey flag it may transmit survey questions to the mobile-phone application. The survey questions may be compiled on the cloud service. In the present embodiment, the link points to a cloud server 700, independent of any manufacturer's support center.

In the present embodiment, the businesses user's software 200 may be a customizable interface for requesting additional information from the consumer. The request may be encrypted in the generated label 100. In a non-limiting example, label 100 customization and generation may be treated as a do-it yourself (DIY) and may be done through a DIY service enabling manufacturers, service providers, and/or consumers to use the platform to generate a machine-readable label. In another non-limiting example, the label 100 creator may use a specified web service and mobile application to customize labels, QR code image or program NFC tag. In the present embodiment, labels that have been created by the business users are considered verified and used when the cloud service submits consumer users' registration request.

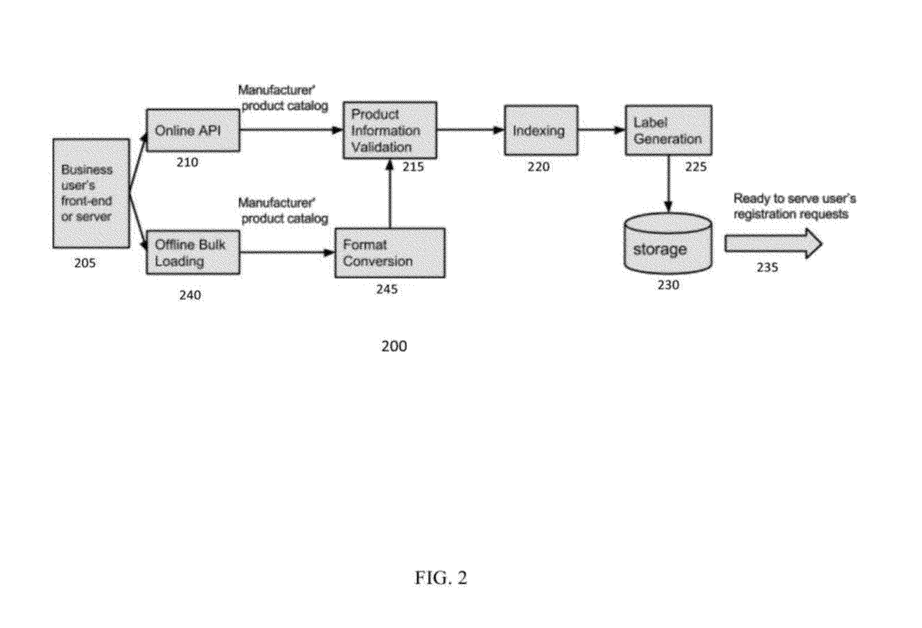

FIG. 2 is a block diagram depicting a manufacturer-facing, cloud-service, label generation, in accordance with an embodiment of the present invention. In the present embodiment, the cloud service 200 for the business user's server 205 may allow each business user to create and to track labels. In the present embodiment, the business user's server 205 may be connected to the cloud server 200 through online application-programming interfaces (APIs) 210. The business user's server may be installed with necessary application-programming interfaces (APIs) for better communication. Through the cloud server's online API 210, access may be granted to the business user's server to load a manufacturer's product catalog. Data may be validated via the product-information validation 215 module. Label may be generated 225 after the validation. Product and label information may be saved in the system 230. Product and label information may be indexed 255 and queried 260. In a non-limiting example, labels may be managed 250 such as, but not limited to, modifying, adding, deleting, via the online API 210. In a non-limiting example, a mechanism may be used to avoid duplicate entries; however, the system may handle duplicate product names. In the present embodiment, once the product information has been validated 215 and indexed 255 according to the manufacturer's requirements, the labels 100 can be generated 225 and the data stored 230 for future decryption 515, ready to serve the users' registration requests. In an optional interface with the business user's software 200, the business server 205 may be connected to the offline bulk loading 240. As a non-limiting example, offline bulking loading 240 may refer to a process of loading the manufacture/business user's existing product catalog into the cloud servers, with human's assistance. Manufacture/business user's product catalog probably may be in any form. To load them into the cloud servers they may need to be converted 245 into a format compatible with online API 210 such that the cloud servers may use a unified backend for processing product catalogs provided in various formats. In some alternate embodiments, business users may use cloud server for generating labels for returned product. As a non-limiting example, a user connects a manufacturer for a return authorization of a product and the manufacturer send the user a label for de-registering the product.

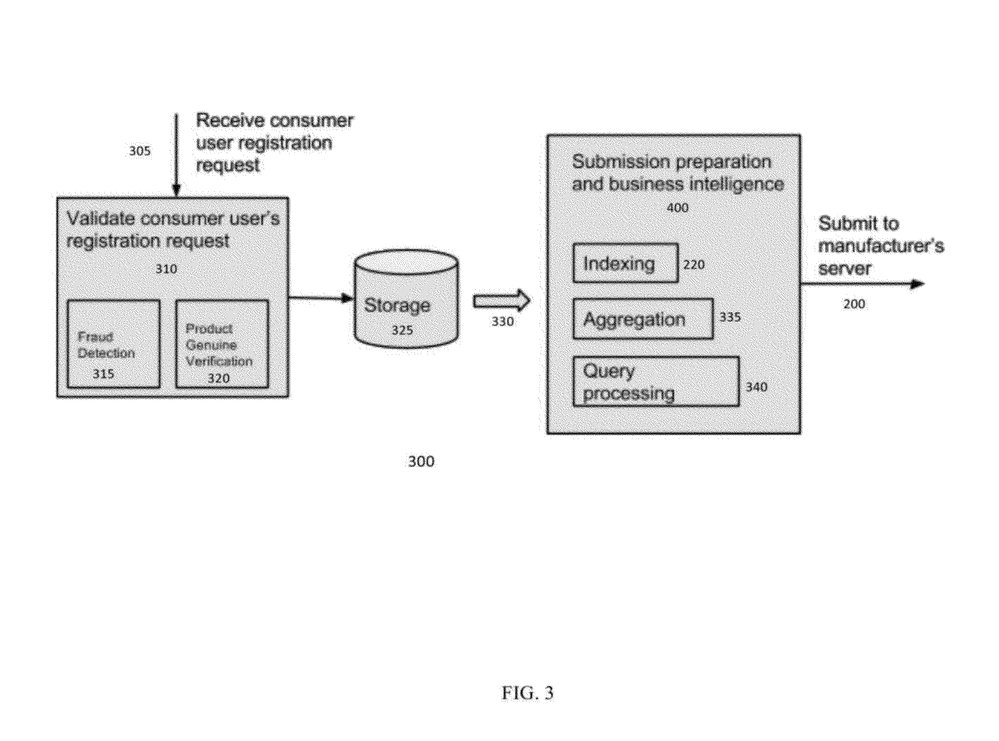

FIG. 3 is a block diagram depicting the processing of a consumer-registration request, in accordance with an embodiment of the present invention. The consumer may use a proprietary, mobile software application 500 to sign up with the product registration service. In a non-limiting example, the consumer provides standard personal information, such as, but not limited to, name, physical address, date of birth, gender, contact-phone number, and email address. The information may be stored within the software application 500 and the cloud server 300 for a one-click registration process. In the present embodiment, when a consumer registers a product, the software application 500 may allow the consumer to scan the label 100 with a camera 505 or an NFC card scanner 510. In the present embodiment, the consumer scans the label 100 within the software application 500. The software application 500 may send the request to cloud service 300. Upon receiving the registration requests 305, the cloud server 300 may validate the request 310 as either a fraud 315, thereby ending the registration process, or may verify the product as genuine 320. This verification 320 may allow the consumer's information and the product information to merge and to be stored 325 within the cloud server 300, which converts the QR code 100 or NFC tag to text and then decrypts the message to access the URL and product information. Upon the consumer's consent, the software application 500 may submit, via the URL, product information with the consumer's standard personal information to the business user's server 205. In a non-limiting example, the software application 500 may, before or after the submission, without limitation, either conduct a survey or request more information, such as, but not limited to, the date of purchase and the name of the store where purchased. With the consumer's information stored 325, the data preparation 330 and business intelligence 400 may allow the information to be sorted prior to submitting it to the business user's server 205. In a non-limiting example, business user's server 205 may be a business's, manufacturer's, service provider's computer server, support center's computer server, cloud server, etc. The consumer's data and product registration data may be indexed 345, may be aggregated 335, or may be queried 340, before being submitted to the manufacturer's server 205.

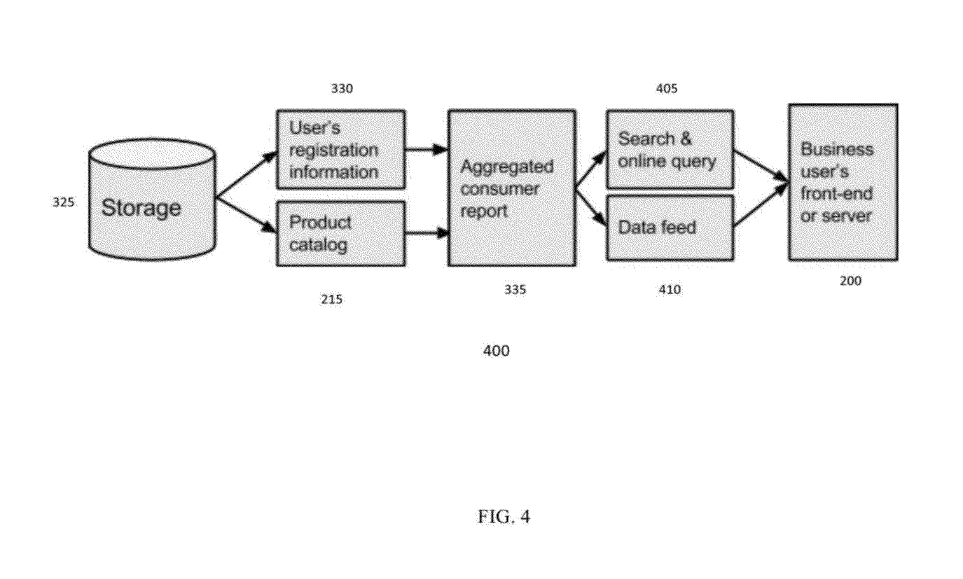

FIG. 4 is a block diagram depicting a manufacturer-facing, business-intelligence service, in accordance with an embodiment of the present invention. In the present embodiment, the manufacturer initializes the request for the customer information, which was gathered from the scanned label 100 and stored 325, through the business intelligence server 400. The information is linked with the consumer's registration information 330 and the manufacturer's product catalog 215 to create an aggregated consumer report 335, which may be used by the manufacturer through a search and query function 405 or as a data feed 410 that redirects the information to the business-user's server 205. In a non-limiting example, the business user may track, for each product, the number of labels that have been printed, shipped, and claimed. In another non-limiting example, the business intelligence interface may allow business users to analyze the registration information for demographic purposes and for the creation of, to queries. In another non-limiting example, the business user may receive real time product registration reports and provide the business users with information to the other products a consumer user registered. In yet another non-limiting example, business users may also create and manage different surveys to have a consumer reply to. In another non-limiting example, business users may access the business intelligence server 400 directly to view the reports.

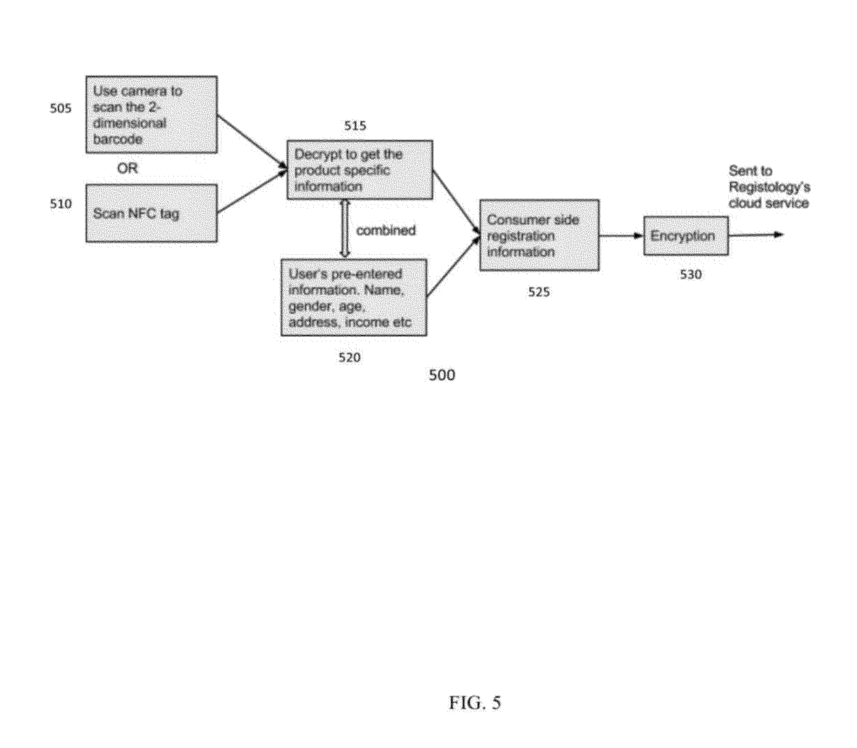

FIG. 5 is a block diagram depicting a consumer-facing, one-touch, scan-to-register, software application, in accordance with an embodiment of the present invention. In the present embodiment, consumers use their cameras on a proprietary mobile device to scan 505 the two-dimensional barcode 100 or to scan the NFC tag 510. The software application 500 may decrypt the barcode or NFC tag 515 to get the product specific information 215. In another embodiment, the software application 500 may contact cloud services 200 to decrypt the label. In another embodiment, the software application 500 may contact cloud services 200, 300, 400 for more information about the product. The software application 500 may combine the product 210 and the saved consumer information 520 as a registration 525 and may encrypt 530 that information so that it may be sent to the cloud service 300. In alternate embodiments, the software application 500 may be configured to operate on various computing devices such as, but not limited to, desktop computers, laptop computers, tablets, smart televisions, gaming consoles, etc., that may communicate with a scanning or image capturing device to capture barcode 100.

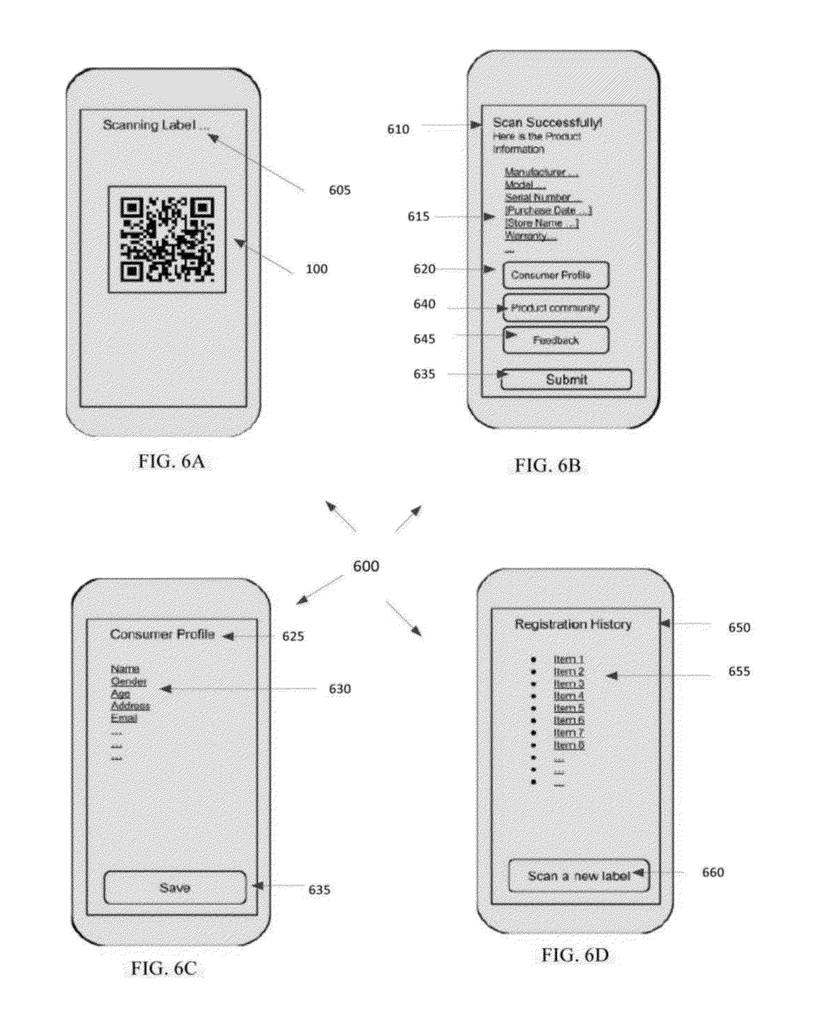

FIGS. 6A-6D illustrate an exemplary software application on a mobile device, in which FIG. 6A is an illustration of the “Scanning Label” page, FIG. 6B is an illustration of the “Scan Successful” page, FIG. 6C is an illustration of the “Consumer Profile” page, and FIG. 6D is an illustration of the “Registration History” page, in accordance with an embodiment of the present invention. In the present embodiment, when the consumer accesses the graphical user interface (GUI) 600 and “Scanning Label” page 605, the proprietary camera is ready to scan the registration label 100. Once the GUI 600 completes the scan, it automatically jumps to the “Scan Successful” page 610, displays the decrypted product information 615 and waits for the consumer to submit via the button 635. Once the submit button 635 is activated, the product and consumer information is transferred to the business user's server 200. The consumer may edit his profile via the consumer-profile button 620 before or after the submission. Once the consumer-profile button 620 is activated, the consumer is taken to the “Consumer Profile” page 625 to edit his/her profile 630. When editing is completed, the profile information can be saved via the save button 635 located at the bottom of the “Consumer Profile” page 625. At any time, the user can browse the registration history via the “Registration History” page 650, which contains the saved registrations with multiple manufacturers 655. Consumers who have registered a product can enter the “Product Community” page via the button 640 on the “Scan Successful” page 610 as a forum to provide product reviews and socialize with other users. In a non-limiting example, a user who has a verified registration will be flagged as the true end user, which will lend credibility to his input in the community. Consumers can also provide feedback to the business user via 200 via the button 645 on the “Scan Successful” page 610.

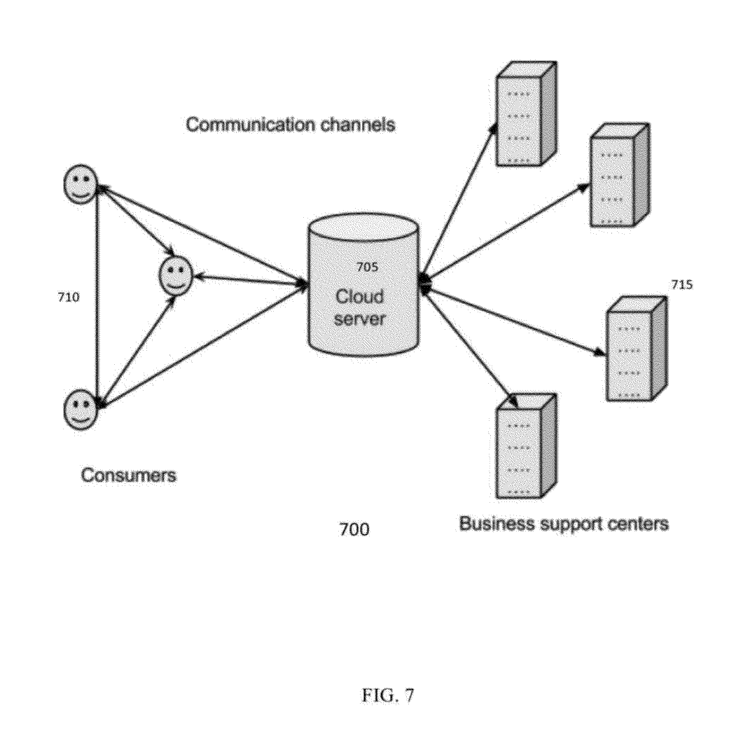

FIG. 7 illustrates an exemplary communication channel, in accordance with an embodiment of the present invention. In the present embodiment, the data transmitted online may be encrypted and secured. Communication channels may be established with the support of the cloud server system 700. Consumers may communicate with each other 710 as may manufacturers with service providers 715. In a non-limiting example, a business user may send either a broadcast or a unicast to its consumers. In another non-limiting example, consumers may support each other through forums and community support interfaces where, by using the manufacturer provided machine readable label 100 or NFC tag, the validation software 310 has already verified the user and the product as legitimate. In yet another non-limiting example, once the users and products are verified, product owners may be grouped as a separate community. In the present embodiment, the cloud server system 700 provides a platform for consumers 710 to register multiple products from multiple manufacturers 715. The cloud server system 700 is capable of having multiple communication platforms to consolidate the product registration process as cloud server system 700 communicates with support center servers of multiple manufacturers and vendors as a hub connecting consumers 710 and multiple manufacturers 715. The cloud server system 700 may enable consumer to manufacturer communication. In a non-limiting example, consumer to manufacturer may be a dedicated channel to provide product feedback to the manufacturer within the software application during and after registration process. Moreover, in the present embodiment, the cloud server system 700 may enable a manufacturer to consumer communication channel. In a non-limiting example, manufacturers may be allowed to send messages to verified registered consumers within the software application. In another non-limiting example, manufacturer generated messages to the consumer may be, but not limited to, an important warning, a product recall, or a new term. In the present embodiment, the cloud server system 700 may enable a system to manufacturer communication channel. In a non-limiting example, the cloud server system 700 may perform a product registration analysis in real time and send the intelligence to a manufacturer accordingly. In the present embodiment, the cloud server system 700 may enable system to consumer communication channel. In a non-limiting example, based on known product information such as, but not limited to, the manufacture date and the user's purchase date, the service may keep track of any product warranty information and notify users when a warranty is going to expire.

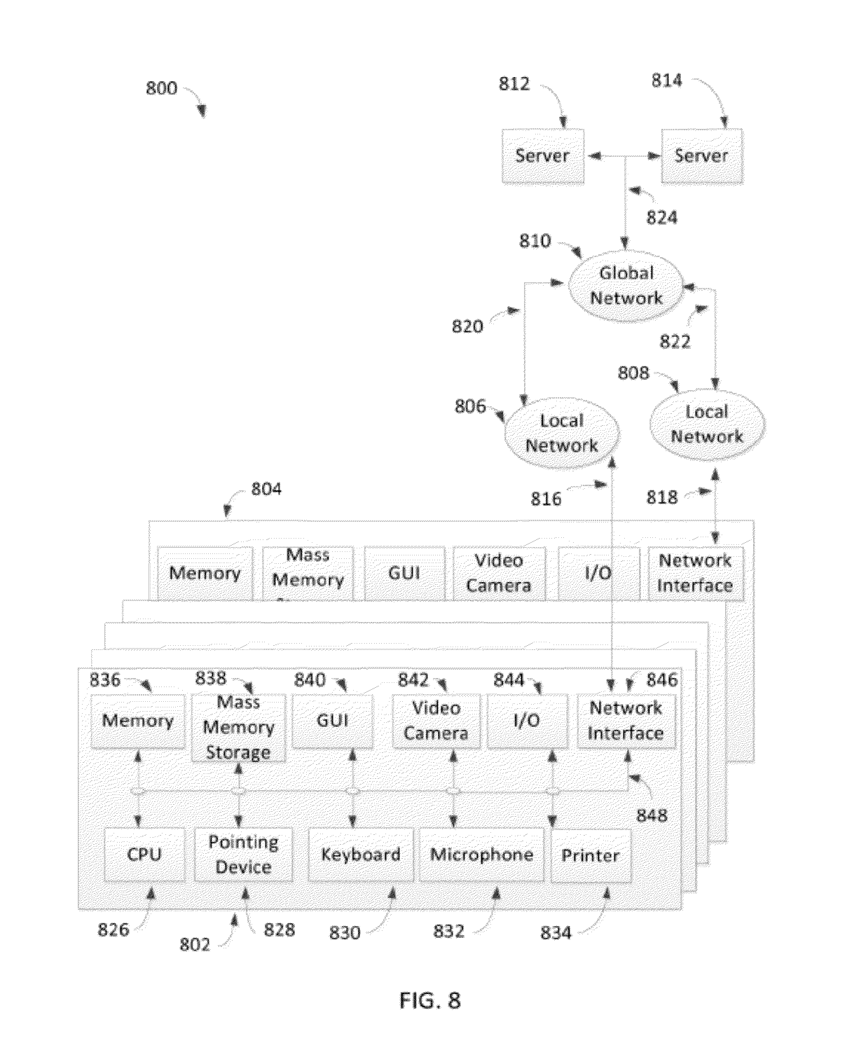

FIG. 8 is a block diagram depicting an exemplary client/server system which may be used by an exemplary web-enabled/networked embodiment of the present invention. A communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, personal digital assistants (PDAs), cellular phones and smartphones.

Client 802 includes a CPU 826, a pointing device 828, a keyboard 830, a microphone 832, a printer 834, a memory 836, a mass memory storage 838, a GUI 840, a video camera 842, an input/output interface 844, and a network interface 846.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 836 is used typically to transfer data and instructions to CPU 826 in a bi-directional manner. Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 830. Keyboard 830 enables a user with the capability to input alphanumeric textual information to CPU 826. CPU 826 may be coupled to microphone 832. Microphone 832 enables audio produced by a user to be recorded, processed and communicated by CPU 826. CPU 826 may be connected to printer 834. Printer 834 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

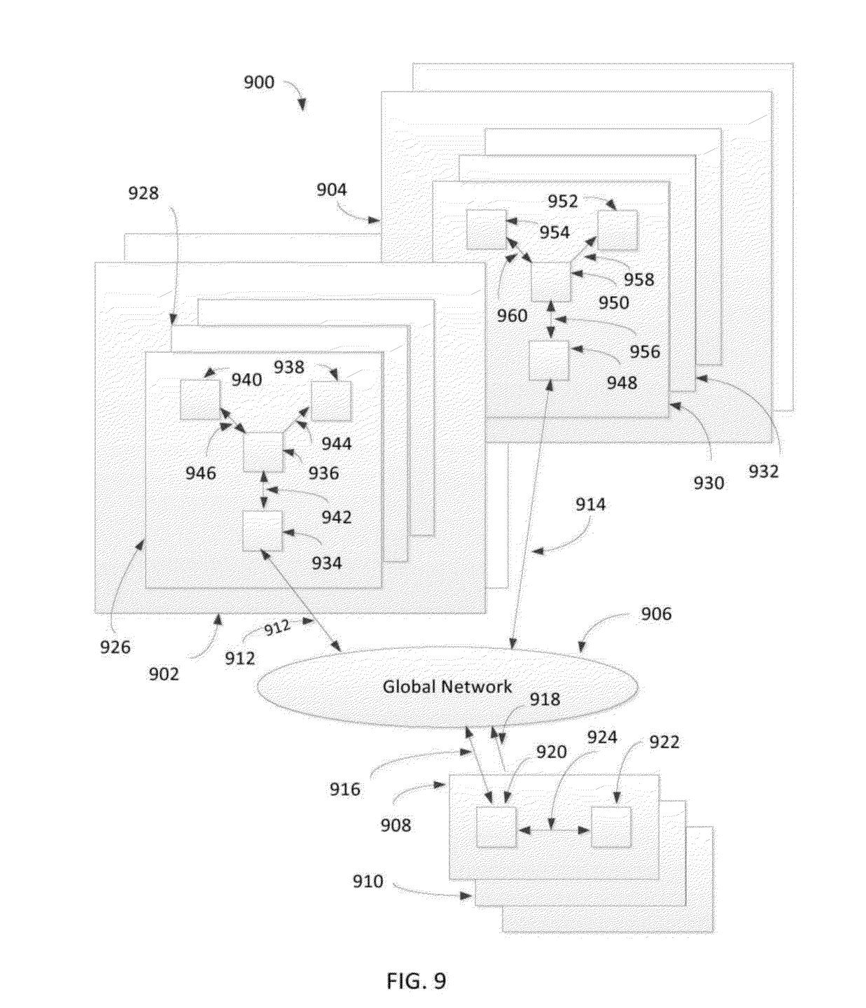

FIG. 9 illustrates a block diagram depicting a conventional client/server communication system. A communication system 900 includes a multiplicity of networked regions with a sampling of regions denoted as a network region 902 and a network region 904, a global network 906 and a multiplicity of servers with a sampling of servers denoted as a server device 908 and a server device 910.

Network region 902 and network region 904 may operate to represent a network contained within a geographical area or region. Non-limiting examples of representations for the geographical areas for the networked regions may include postal zip codes, telephone area codes, states, counties, cities and countries. Elements within network region 902 and 904 may operate to communicate with external elements within other networked regions or within elements contained within the same network region.

In some implementations, global network 906 may operate as the Internet. It will be understood by those skilled in the art that communication system 900 may take many different forms. Non-limiting examples of forms for communication system 900 include local area networks (LANs), wide area networks (WANs), wired telephone networks, cellular telephone networks or any other network supporting data communication between respective entities via hardwired or wireless communication networks. Global network 906 may operate to transfer information between the various networked elements.

Server device 908 and server device 910 may operate to execute software instructions, store information, support database operations and communicate with other networked elements. Non-limiting examples of software and scripting languages which may be executed on server device 908 and server device 910 include C, C++, C# and Java.

Network region 902 may operate to communicate bi-directionally with global network 906 via a communication channel 912. Network region 904 may operate to communicate bi-directionally with global network 906 via a communication channel 914. Server device 908 may operate to communicate bi-directionally with global network 906 via a communication channel 916. Server device 910 may operate to communicate bi-directionally with global network 906 via a communication channel 918. Network region 902 and 904, global network 906 and server devices 908 and 910 may operate to communicate with each other and with every other networked device located within communication system 900.

Server device 908 includes a networking device 920 and a server 922. Networking device 920 may operate to communicate bi-directionally with global network 906 via communication channel 916 and with server 922 via a communication channel 924. Server 922 may operate to execute software instructions and store information.

Network region 902 includes a multiplicity of clients with a sampling denoted as a client 926 and a client 928. Client 926 includes a networking device 934, a processor 936, a GUI 938 and an interface device 940. Non-limiting examples of devices for GUI 938 include monitors, televisions, cellular telephones, smartphones and PDAs (Personal Digital Assistants). Non-limiting examples of interface device 940 include pointing device, mouse, trackball, scanner and printer. Networking device 934 may communicate bi-directionally with global network 906 via communication channel 912 and with processor 936 via a communication channel 942. GUI 938 may receive information from processor 936 via a communication channel 944 for presentation to a user for viewing. Interface device 940 may operate to send control information to processor 936 and to receive information from processor 936 via a communication channel 946. Network region 904 includes a multiplicity of clients with a sampling denoted as a client 930 and a client 932. Client 930 includes a networking device 948, a processor 950, a GUI 952 and an interface device 954. Non-limiting examples of devices for GUI 938 include monitors, televisions, cellular telephones, smartphones and PDAs (Personal Digital Assistants). Non-limiting examples of interface device 940 include pointing devices, mousse, trackballs, scanners and printers. Networking device 948 may communicate bi-directionally with global network 906 via communication channel 914 and with processor 950 via a communication channel 956. GUI 952 may receive information from processor 950 via a communication channel 958 for presentation to a user for viewing. Interface device 954 may operate to send control information to processor 950 and to receive information from processor 950 via a communication channel 960.

For example, consider the case where a user interfacing with client 926 may want to execute a networked application. A user may enter the IP (Internet Protocol) address for the networked application using interface device 940. The IP address information may be communicated to processor 936 via communication channel 946. Processor 936 may then communicate the IP address information to networking device 934 via communication channel 942. Networking device 934 may then communicate the IP address information to global network 906 via communication channel 912. Global network 906 may then communicate the IP address information to networking device 920 of server device 908 via communication channel 916. Networking device 920 may then communicate the IP address information to server 922 via communication channel 924. Server 922 may receive the IP address information and after processing the IP address information may communicate return information to networking device 920 via communication channel 924. Networking device 920 may communicate the return information to global network 906 via communication channel 916. Global network 906 may communicate the return information to networking device 934 via communication channel 912. Networking device 934 may communicate the return information to processor 936 via communication channel 942. Processor 946 may communicate the return information to GUI 938 via communication channel 944. User may then view the return information on GUI 938.

In another embodiment, instead of using mobile device, a consumer user may fill out registration form on a website manually as there is no available camera to use. In another embodiment, instead of using QR code 100 or NFC tag, the consumer user may fill out digital form manually. In another embodiment, instead of using QR code 100 or NFC tag, the consumer user may scan other kinds of optical code including images, barcodes, and RFID tags. In another embodiment, instead of using QR code 100 or NFC tag, the consumer user may scan human readable text and run optical character recognition (OCR) software on the existing packaging label. In another embodiment, instead of running an individual mobile application on a mobile device, the consumer facing work may be done in a web page opened in the mobile device's own web browser in which the web page provides camera functions and the rest of required functions to complete online product registration. In some embodiments, the mobile application may be a dedicated application that may be also be integrated to an existing social network application as an integrated service. In a non-limiting example, an app may be created or use a service for, but not limited to, Facebook®, WhatsApp®, or Instagram®. In another embodiment, the product registration information may be consolidated in any other method for the purpose of building self-help community and customer service.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: web site hosting and cloud storage for databases.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a cloud based platform for product registration according to the present invention will be apparent to those skilled in the art. Various aspects of the invention have been described above by way of illustration, and the specific embodiments disclosed are not intended to limit the invention to the particular forms disclosed. The particular implementation of the cloud based platform for product registration may vary depending upon the particular context or application. By way of example, and not limitation, the cloud based platform for product registration described in the foregoing were principally directed to multiple vendor registration implementations; however, similar techniques may instead be applied to other useful implementations, such as, without limitation, other barcode readers to gather pre-saved consumer information, registration for services rendered such as an auto mechanic or a maid service, and for scheduling and/or organizing systems, which the implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
capturing a product identifier for a product obtained by a user, said product identifier being compiled by a cloud based server system as instructed by a one of a plurality business users of a plurality of different businesses;
extracting information from said product identifier, said extracted information at least comprising a code which uniquely identifies said product and a network address for establishing a communication with said cloud based server system;
obtaining personal information from the user;
establishing a communication with said cloud based server system using said network address; and
communicating said code and said personal information to said cloud based server system for registering said product, whereby said code and personal information are available for a cloud connected support center of a business of the business user to receive for use in a registration of said product.

2. The method as recited in claim 1, further comprising the step of communicating a second code for a second product obtained by the user and said personal information to said cloud based server system for registering said second product, said cloud based server system storing said second code with said personal information and transmitting said code and said personal information to a support center of a business associated with said second product to use in a registration of said second product.

3. The method as recited in claim 1, further comprising the step of communicating results of a survey taken by the user to said cloud based server system, said survey being initiated by a survey code in said product identifier.

4. The method as recited in claim 1, further comprising the step of communicating with said cloud based server system for accessing a communication channel between the user and the business.

5. The method as recited in claim 1, further comprising the step of communicating with said cloud based server system for accessing a communication channel between the user and another user of said cloud based server system.

6. The method as recited in claim 1, in which said extracting further comprises decrypting said information.

7. The method as recited in claim 1, in which said cloud based server system validates said code using said stored information for said product identifier.

8. The method as recited in claim 1, in which said cloud based server system provides reports to the business user at least in part based on said stored information.

9. The method as recited in claim 1, in which said product identifier comprises a label.

10. A system comprising:
a client computing device being configured for capturing a product identifier for a product obtained by a user, extracting information from said product identifier, said extracted information at least comprising a code which uniquely identifies said product and a network address for establishing a communication, obtaining personal information from the user, establishing a communication using said network address, and communicating said code and said personal information; and
a server system having a cloud based operation at said network address, said server system being configured for compiling said product identifier as instructed by a one of a plurality business users of a plurality of different businesses, information for said product identifier being stored by said server system, said server system being further configured for receiving said code and said personal information and storing said code and said personal information, said server system being further configured for transmitting said code and said personal information to a support center of a business of the business user to use in a registration of said product.

11. The system as recited in claim 10, in which said client computing device is further configured for decrypting said information during said extracting, communicating results of a survey taken by the user to said server system, said survey being initiated by a survey code in said product identifier, communicating with said server system for accessing a communication channel between the user and the business, communicating with said server system for accessing a communication channel between the user and another user of said server system, and communicating a second code for a second product obtained by the user and said personal information to said server system for registering said second product, said server system being further configured for storing said second code with said personal information and transmitting said code and said personal information to a support center of a business associated with said second product to use in a registration of said second product, said server system being further configured for validating said code and said second code using said stored information and providing reports to the business user at least in part based on said stored information.

12. A non-transitory computer-readable storage medium with an executable program stored thereon, wherein the program instructs one or more processors to perform the following steps:
capturing a product identifier for a product obtained by a user, said product identifier being compiled by a cloud based server system as instructed by a one of a plurality business users of a plurality of different businesses;
extracting information from said product identifier, said extracted information at least comprising a code which uniquely identifies said product and a network address for establishing a communication with said cloud based server system;
obtaining personal information from the user;
establishing a communication with said cloud based server system using said network address; and
communicating said code and said personal information to said cloud based server system for registering said product, whereby said code and personal information are available for a cloud connected support center of a business of the business user to receive for use in a registration of said product.

13. The program instructing the processor as recited in claim 12, further comprising the step of communicating a second code for a second product obtained by the user and said personal information to said cloud based server system for registering said second product, said cloud based server system storing said second code with said personal information and transmitting said code and said personal information to a support center of a business associated with said second product to use in a registration of said second product.

14. The program instructing the processor as recited in claim 12, further comprising the step of communicating results of a survey taken by the user to said cloud based server system, said survey being initiated by a survey code in said product identifier.

15. The program instructing the processor as recited in claim 12, further comprising the step of communicating with said cloud based server system for accessing communication channel between the user and the business.

16. The program instructing the processor as recited in claim 12, further comprising the step of communicating with said cloud based server system for accessing communication channel between the user and another user of said cloud based server system.

17. The program instructing the processor as recited in claim 12, in which said extracting further comprises decrypting said information.

18. The program instructing the processor as recited in claim 12, in which said cloud based server system validates said code using said stored information for said product identifier.

19. The program instructing the processor as recited in claim 12, in which said cloud based server system provides reports to the business user at least in part based on said stored information.

20. The program instructing the processor as recited in claim 12, in which said product identifier comprises a label.
